(19) United States
(12) Patent Application Publication
(10) Pub. No.: US 2002/0069756 A1
(43) Pub. Date: Jun. 13, 2002

(54) Method and apparatus for regeneration of particulate filter using microwave energy

(76) Inventors: Frederick M. Mako, Fairfax Station, VA (US); Richard Silberglitt, Fairfax, VA (US)

Correspondence Address: Ansel M. Schwartz, Suite 304, 201 N. Craig Street, Pittsburgh, PA, 15213, US

(21) Appl. No.: 10/045,273

(22) Filed: Jan. 18, 2002

Related U.S. Application Data
(63) Continuation of application No. 08/920,686, filed on Aug. 29, 1997, now abandoned.
Application No. 08/920,686 is a continuation-in-part of application No. 08/548,557, filed on Oct. 26, 1995, now abandoned.

(51) Int. Cl. B01D 53/02; B01D 59/26

(52) U.S. Cl. 95/148

(57) ABSTRACT

A regeneration system includes at least two microwave sources for producing microwaves. There is also a microwave cavity in communication with the microwave sources to receive the microwaves. Additionally, there is a particulate filter disposed in the cavity which is heated by the microwaves in the cavity. Alternatively, there can be at least one microwave source with the microwave cavity having a plurality of ports through which microwaves from the microwave source enter the cavity. A method for regenerating a particulate filter comprising the steps of passing exhaust through the particulate filter. Then, there is the step of heating the particulate filter from a plurality of directions with microwaves.

### FIELD OF THE INVENTION

The present invention is related to a regeneration system of a particulate filter. More specifically, the present invention relates to a regeneration system of a particulate filter using multiple inputs of microwaves.

### BACKGROUND OF THE INVENTION

Particulate filters are used in many industrial applications to trap and prevent the release of potential pollutants such as hydrocarbons, metals and carbon generated from combustion processes. An important application is the removal of carbon which is produced in the form of soot from diesel engine exhaust. A number of filtration schemes have been developed for collecting this carbon, one of which is the wall-flow filter in which the carbon particulates are trapped in the walls of a filter placed in the exhaust stream. The wall-flow filter has flow channels oriented parallel to the direction of the exhaust flow, with neighboring channels blocked in alternate directions. This forces the flow through the walls of the filter, where the carbon particulates are trapped in the porous ceramic filter material. Another type of filter is fabricated from a ceramic foam, which traps the particulates directly. In either case, when the filter reaches a certain level of carbon loading, the back pressure produced in the exhaust system degrades the performance of the engine sufficiently that the filter must be “regenerated” by removing the carbon. This is accomplished by raising the temperature of the filter to 600-800 degrees C in the presence of oxygen, which causes combustion of the carbon particulates to form CO₂, which is then released through the exhaust stream.

A variety of methods have been examined to regenerate diesel engine particulate filters, including increasing engine thrust to raise the exhaust temperature [K. N. Pattas et al, Society of Automotive Engineers (SAE) Paper No. 860136 (1986)], ignition of the carbon using electrical resistance heaters [M. Arai et al, SAE Paper No. 870012 (1987)], and microwave heating of the filter and carbon particulates [C. P. Garner and J. C. Dent, SAE Paper No. 890174 (1989); F. B. Walton et al, SAE Paper No. 900327 (1990); M. J. Faure and M. L. Chan, Lyon Diesel Congress, Apr. 14-15 (1993)]. Increasing engine thrust is not practical because it interferes with the operation of the vehicle. Electrical resistance heaters were tested and determined to be unreliable and inefficient. A number of different microwave regeneration methods have been proposed and shown to have various degrees of effectiveness. In all of these, the filter is placed inside a microwave cavity, which is then placed in the exhaust stream. Typically, a ceramic insulation is wrapped between the filter and wall of the microwave cavity. Walton et al placed a microwave absorbing material at each end of the filter, and applied microwave energy to successfully regenerate a wall-flow filter loaded with 20 grams of soot. However, thermal stresses resulting from nonuniform heating reduce the estimated lifetime of the ceramic filter sufficiently to make this method not cost-effective. Garner and Dent used a similar configuration, without the microwave absorbing material but with an exhaust by-pass valve. They used 1 kW of microwave energy applied for 400-500 seconds to preheat a wall-flow filter loaded with 37 grams of particulate to regeneration temperatures and then closed the by-pass valve to promote regeneration. This method achieved only 50% regeneration. Faure and Chan have discussed a microwave regeneration method that uses two filters, together with a control system that directs exhaust flow to one filter and microwaves to the other during regeneration. They also introduce air during microwave heating, which is essential for combustion of the carbon particulates. Faure and Chan determined that 15 grams was the optimum carbon loading for their regeneration system, with which they achieved 73% regeneration efficiency.

While microwave regeneration has been shown to be feasible by the previous work described above, there are two major factors that have prevented the use of this technique in commercial diesel engine powered vehicles. Most important is the nonuniformity of heating, which introduces thermal stresses in the ceramic filter that reduce its lifetime to unacceptable levels. A secondary factor is the necessity to remove the filter from the exhaust stream during regeneration, which requires a valving or by-pass system, or perhaps even a second filter. The invention disclosed herein provides a means for reducing or eliminating the nonuniformity of heating by introducing the microwave energy through multiple ports. These ports can be connected to the microwave source through any conventional means such as waveguides or coaxial cables. A single microwave source can be used, or multiple microwave sources. If multiple microwave sources are used, they can be turned on simultaneously or in any desired pattern using a simple combination of electrical relays and switches. A microwave regeneration system using this method was shown to significantly improve the heating uniformity of unloaded ceramic wall-flow filters and to successfully regenerate a carbon-loaded filter in the presence of exhaust flow.

### SUMMARY OF THE INVENTION

The invention consists of the use of multiple inputs of microwave energy to improve the uniformity of heating of a particulate filter loaded with carbon. When a single microwave input is used, as in previous work, an asymmetric electromagnetic field distribution is produced in the cavity containing the carbon-loaded filter, resulting in nonuniform heating of the filter. By using more than one microwave input, together with one or more microwave power sources, a balance is established that results in a much more uniform electromagnetic field distribution and heating pattern. Numerical simulations of the electromagnetic field inside the cavity can be performed to optimize the number of microwave ports, the number of microwave sources, and the on-off pattern for each source for specific filters and filter configurations. Moreover, any method of porting of the microwave energy from the source into the cavity presently known in the art can be used, e.g., waveguide or coaxial cable. Similarly, any methods of optimizing microwave coupling, such as three-stub or iris tuners, and any diagnostic methods, such as bidirectional couplers to measure transmitted and reflected power, or optical pyrometers or shielded thermocouples to measure temperature of the filter, presently known in the art can be used with this invention. The microwave source or sources can be physically isolated from the exhaust stream using any methods known in the art, such as microwave transparent windows and acoustic isolation techniques. The microwave source or sources can also be protected against damage from reflected power using readily available microwave components such as circulators or isolators or a filter that serves as a good microwave load or absorber that creates a non-damaging reflection. The preferred embodiment of the invention described below uses two microwave sources and two ports connected through waveguides, but the method is generally applicable to any number of sources and ports and any connection means. In fact, coaxial cable microwave feed may be preferred on many types of diesel powered vehicles.

### BRIEF DESCRIPTION OF THE DRAWINGS

In the accompanying drawings, the preferred embodiment of the invention and preferred methods of practicing the invention are illustrated in which:

FIG. 1 is a schematic representation of the preferred embodiment.

FIG. 2 is a graph of heating data for single microwave source and single port.

FIG. 3 is a graph of axial variation of heating profile with single microwave source and single port.

FIG. 4 is a graph of a heating profile with two alternating microwave sources and two ports.

FIG. 5 is a graph of a comparison of heating profiles with two microwave sources on continuously or turned on alternately.

FIG. 6 is a graph of heating and back pressure data for engine test of microwave regeneration of carbon-loaded filter.

### DESCRIPTION OF THE PREFERRED EMBODIMENT

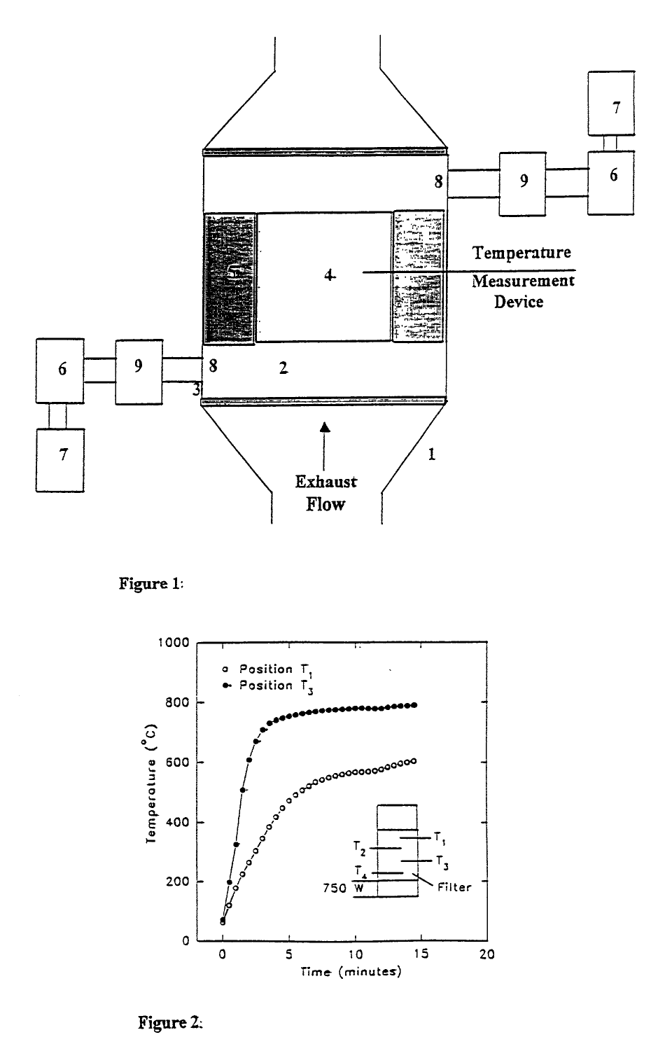

Referring now to the drawings wherein like reference numerals refer to similar or identical parts throughout the several views, and more specifically to FIG. 1 thereof, there is shown a representation of the preferred embodiment of this invention. Exhaust from a diesel engine flows in the direction indicated by the arrow into a metal exhaust pipe 1 which contains a microwave cavity 2. The microwave cavity is defined by the walls of the exhaust pipe and a pair of perforated metal end plates 3. The microwave cavity in this embodiment is of cylindrical geometry, but the invention can be used with a cavity of arbitrary geometry. A particulate filter 4 is placed in the center of the microwave cavity and surrounded by high temperature ceramic insulation 5, for example, aluminosilicate fibers in a blanket or mat. In this embodiment, the filter is a wall-flow filter fabricated from aluminum oxide coated with a layer of silicon carbide in order to enhance the microwave heating, as described in Nixdorf, U.S. Pat. No. 5,087,272. However the invention can be used with any type of particulate filter. Microwave heating is accomplished with the use of two 2.45 GHz magnetrons and power sources 6 and 7, respectively. CW magnetrons producing up to 1 or 2 kilowatts of microwave power that are widely available commercially are used in this embodiment, but any CW microwave sources can be used with this invention. The power sources can be driven using wall plug power (e.g., 110 V AC in the U.S.) or using a vehicle alternator. In the latter case, a DC to DC converter is required to power the magnetrons with the voltage output of the alternator. The magnetrons are connected via waveguide or coaxial cable, or other electrical connection means, to ports 8 that are placed at opposite ends of the cavity so that the filter is interposed between the ports. The microwave energy is introduced into the cavity using conventional means, e.g., through a waveguide launching structure or an antenna inserted into the cavity, depending upon the porting method used. The placement of the ports on opposite sides of the filter provides the necessary attenuation so that only a small fraction (less than 10%) of the microwave power from one magnetron reaches the other magnetron port. Additional microwave components 9 can be incorporated into this microwave regeneration system as needed. For example, a tuning means such as a three-stub tuner or iris can be used to reduce the reflected power. Isolators or circulators can be used to capture any reflected microwave power. Windows can be used to protect the microwave components and magnetron from exhaust gases. Various diagnostics, such as bidirectional couplers to measure transmitted and reflected power, can also be used. Finally, the temperature within the filter can be measured using standard means such as shielded thermocouples or an optical pyrometer and the regeneration process can be viewed using a camera connected through an optical fiber. Any of these diagnostics can be inserted through pressure fittings in the wall of the microwave cavity or exhaust pipe. This description of the preferred embodiment is one concrete example and is not intended to limit the scope of the invention. Any type of filter, filter geometry, microwave cavity, number and arrangement of microwave sources and ports and any other type of microwave porting, isolation, tuning or diagnostics known in the art can be used with this invention.

In the operation of the preferred embodiment, the metal exhaust pipe [1] has a cylindrical section of 7″ outer diameter fabricated from 304 or 409 stainless steel with a wall thickness of 0.0625-0.125″ and at least 12″ long. The microwave cavity [2] is defined by the walls of this exhaust pipe section and two cylindrical perforated stainless steel end plates [3] of the same diameter as the exhaust pipe and 0.125″ thick. Each end plate has an array of holes of 0.25″ diameter that are spaced 0.5″ apart. These holes provide sufficient exhaust flow for unimpeded engine operation. The end plates are welded to the inner wall of the stainless steel exhaust pipe, thus providing a termination to the microwave cavity that prevents leakage of microwave power. The particulate filter [4] is a silicon carbide-coated aluminum oxide wall-flow filter (See, e.g., Garner and Dent, and Nixdorf.) 6″ in diameter and 6″ long that is held in place in the center of the microwave cavity by mechanical force transmitted between the outer wall of the filter and the inner wall of the exhaust pipe by an intumescent ceramic mat [5] wound in a tourniquet fashion.

Microwave power is introduced into the cavity through ports [8] that are fabricated from 2-3″ long sections of 304 stainless steel WR 284 waveguide welded to the outer wall of the exhaust pipe at a position halfway between the filter and the perforated end plates. Each microwave power source is a 2.45 GHz magnetron [6] providing up to 1000 watts of continuous power. The power supply [7] for each magnetron operates with 110 V AC prime power, and a fan is used to cool each magnetron during operation. Each magnetron is mounted inside a wave launcher [9] consisting of a section of WR 284 waveguide with a hole large enough to accommodate the magnetron antenna. These wave launchers are connected to the ports [8] welded to the exhaust pipe [1] using bolted flanges.

The use of 110 V AC prime power was for convenience. It is also possible to drive the magnetrons using other power sources, such as a vehicle alternator. In this case a DC to DC converter would be used to produce the 4 kV required by the magnetron. Microwave power could also be fed to the cavity using coaxial cables (e.g., Andrews ⅞″ LDF5-50A Foam Dielectric Heliax®) rather than waveguide. In this case, standard waveguide-to-coax and standard coax-to-waveguide converters would be used. If it were desirable to eliminate the waveguide or coax entirely, the microwave power could also be launched directly by connecting the magnetron(s) to the cavity with a proper wave launcher.

In order to protect the microwave components from the exhaust gases, a microwave transparent pressure window is used. The window is a 0.25″ thick quartz or alumina disk placed inside a stainless steel flange and sealed with silicone adhesive. The flange is bolted in place in between the wave launcher [9] and the microwave port [8] that is welded to the exhaust pipe [1].

During the heating experiments described under Examples 1 and 2, temperature measurement was made using shielded type L thermocouples 0.125″ in diameter. Temperature was observed on a calibrated LED display and plotted on an analog chart recorder. The magnetrons were protected from reflected power using ferrite circulators and reflected power was minimized using standard three-stub tuners. Standard bidirectional couplers were used to monitor both input and reflected power.

During the heating experiments described under Example 1, the power to the magnetrons was controlled using a set of relays to alternately switch on and off the prime power to the magnetron power supplies. In both Examples 1 and 2 the thermocouples were inserted into the filter body through pressure fittings that were welded to the exhaust pipe and through holes drilled for this purpose into the exhaust pipe, ceramic mat, and filter body.

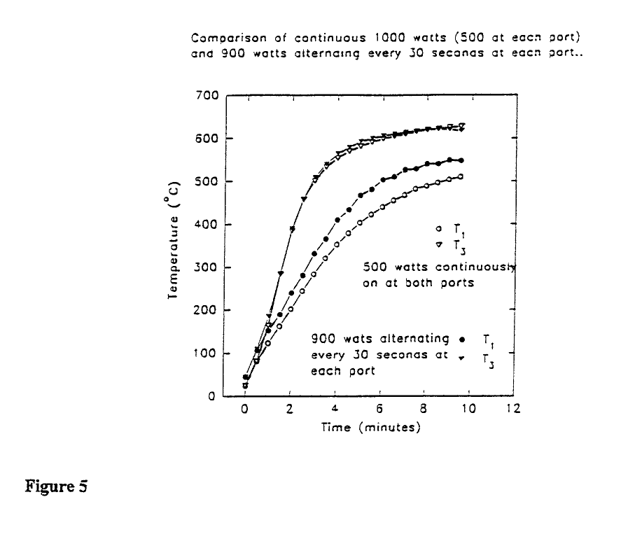

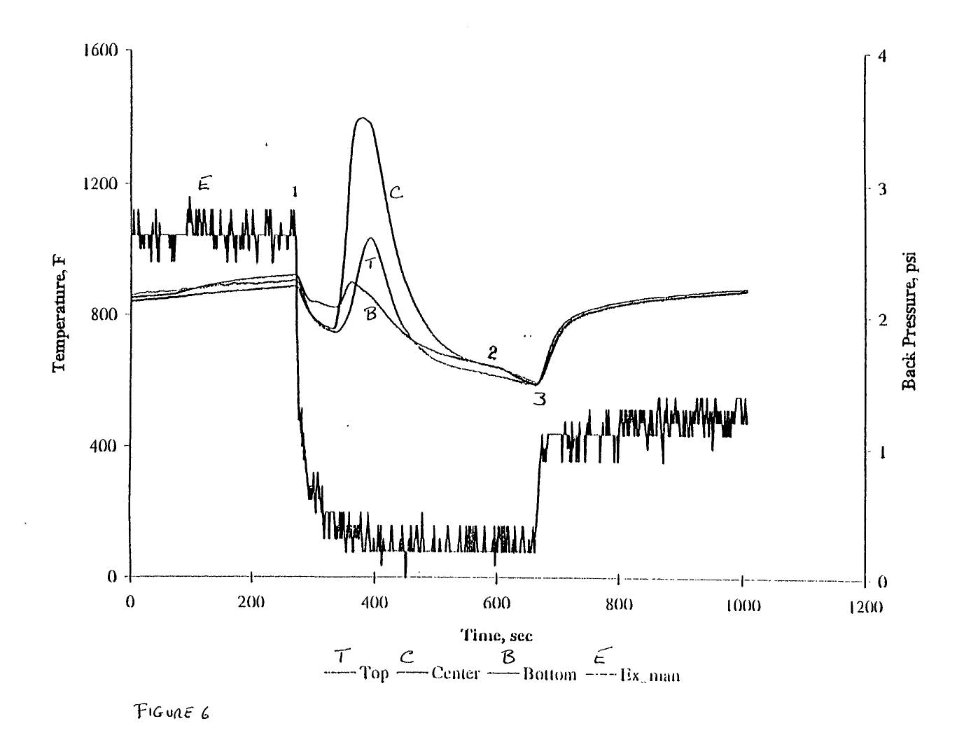

In the preferred embodiment of the device, electromagnetic energy in the form of a traveling wave oscillating at a frequency of 2.45 GHz is produced by a magnetron oscillator [6] and directed through a metallic waveguide into a metallic cavity [2] containing the particulate filter [4]. The microwave energy is reflected by the walls of the cavity and penetrates the filter and the ceramic insulation around the filter. In passing through the filter, a portion of the microwave energy is absorbed by the carbon in the filter and by the silicon carbide-coated aluminum oxide filter material, thus causing heating of the filter to the regeneration temperature and simultaneously attenuating the electromagnetic field. In previously demonstrated microwave regeneration methods, the microwave energy is introduced from a single microwave source and through a single microwave port. Because of the attenuation of the field by the carbon-loading and filter material, which must occur if there is heating, the electromagnetic field intensity is always greater in the part of the filter nearest to the microwave port than in the part of the filter farthest from the microwave port. This produces a nonuniform heating distribution. In the preferred embodiment, two microwave sources [6] and two microwave ports [8] are used. The microwave energy thus enters the cavity [2] symmetrically, and is reflected from the metallic walls and penetrates the two ends of the filter in a similar fashion and with similar intensity on both sides of the filter. The result is a more uniform heating distribution, as shown in Example 1. When both microwave sources are on continuously, the microwaves from each side of the filter result in a more symmetric power flow. However, when the microwave sources are turned on and off alternately, the filter is irradiated by microwaves from only one side at any given time. By judicious choice of the duration and frequency of the microwave power cycle, it is possible to heat the entire filter to a high degree of uniformity, as shown in FIG. 5. In this case, the microwaves introduced on one side of the filter are attenuated primarily by that side of the filter. During the off time of the microwave source, the heat produced by that source is then distributed throughout the filter. Simultaneously during this off time, the other microwave source is heating the other side of the filter. This process is repeated until an equilibrium is established in which the heat is distributed throughout the filter with great uniformity.

It is important to note that although the preferred embodiment uses a particulate filter [4] composed of microwave absorbing material, this method will work with any type of particulate filter. The microwaves can be absorbed by the carbon particulates trapped in the filter, the filter material itself, any combination of these, or any other means. Moreover, while the preferred embodiment uses two microwave sources [6] and two microwave ports [8], the method will work with any number of microwave sources and any number of microwave ports such that there is approximately symmetric power flow. Far example, one microwave source could be directed to two or more ports using standard waveguide splitters or standard waveguide-to-coax converters and standard coax-to waveguide converters, together with standard coaxial cables. The microwave sources may also be turned on continuously or in any desired on-off pattern using standard electrical switches and timers.

The following section provides examples of data obtained in a laboratory with a prototype device that demonstrates the efficacy of the invention.

### EXAMPLE 1

Heating of an Unloaded Particulate Filter

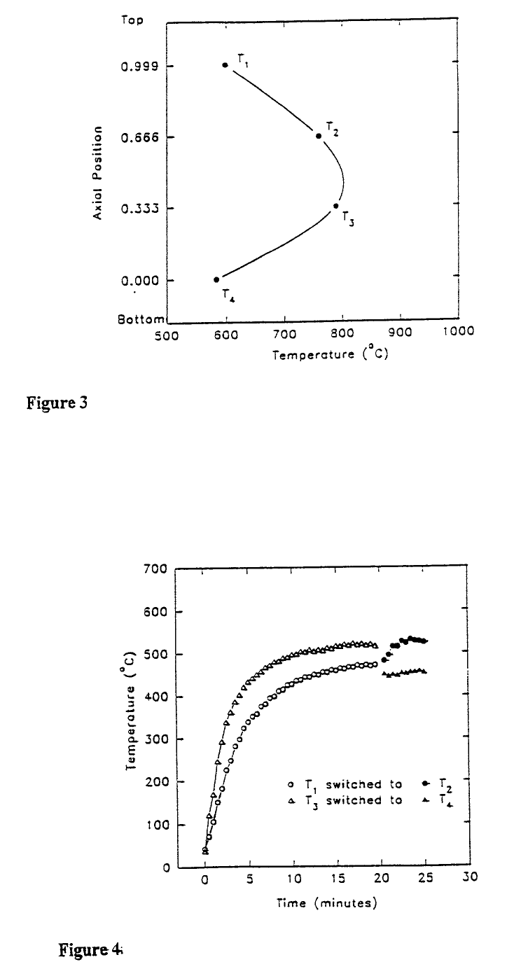

A particulate filter was mounted in a microwave cavity and heated using a number of different microwave source and porting configurations. First, a conventional single source method was used. In this case, a 750 Watt CW magnetron source operating at 2.45 GHz was attached through the lower port indicated in FIG. 1. FIG. 2 shows the heating data, which was obtained using four thermocouples that were inserted into the filter through the walls of the cavity as indicated in the diagram in FIG. 2. FIG. 3 shows the axial variation of the temperature profile in this single source microwave heating experiments A temperature gradient of approximately 200 degrees C is observed. Next, the two port microwave regeneration system described in the previous section and illustrated schematically in FIG. 1 was attached to the cavity and used to heat this filter by applying 750 Watts from two microwave sources that were connected through the two ports shown in FIG. 1. The microwave sources were turned on alternately every 30 seconds. FIG. 4 shows the heating profile, indicating the significantly improved temperature uniformity, with the temperature gradient reduced to approximately 100 degrees C. The effect of alternating the two sources is shown in FIG. 5, which compares heating with the two sources on continuously to the alternating source heating shown in FIG. 4. The result demonstrates that two source heating improves temperature uniformity over the single source in both cases, but that alternating heating provides the greatest level of uniformity.

### EXAMPLE 2

Regeneration of a Carbon-Loaded Particulate Filter

A particulate filter was placed in a microwave cavity as shown in FIG. 1 and then attached to the exhaust stream of a single cylinder diesel engine in a test cell. Two 1 kilowatt CW microwave sources operating at 2.45 GHz were attached to the microwave cavity containing the filter in the configuration shown in FIG. 1. The diesel engine was operated for approximately 15 hours in order to load the filter with carbon particulates. The presence of the carbon loading was verified by observing the increase in back pressure of the engine. The engine was then put into an idle condition, and the microwave sources were turned on. The temperature of the filter was monitored throughout this process with three thermocouples that were inserted in the filter body through holes in the cavity wall that were sealed with pressure fittings to prevent exhaust leakage. FIG. 6 shows the microwave regeneration results. The numbers on the figure represent the following sequence of events: 1-Engine thrust reduced to idle, with microwave power turned on very shortly thereafter; 2-Microwave power turned off; and 3-Engine returned to an identical operating condition to that before point 1. The temperature scale for the exhaust temperature and filter thermocouple readings is on the left side of the figure, while the pressure scale for the engine back pressure readings is on the right side of the figure. When the engine thrust was reduced to idle, the exhaust temperature immediately began to decrease, but shortly after the microwave sources were turned on, a rapid increase in the temperature of the filter was observed, such as would result from the initiation of the exothermic reaction of carbon with oxygen to form carbon dioxide. The largest increase in temperature was in the center of the filter, where the convective cooling effect of the exhaust stream is minimized by the presence of pockets of carbon particulates that provide enough insulation to allow the ignition temperature to be reached. The fact that the microwave heating was able to ignite the carbon particulates in the center of the filter is a demonstration that the filter was heated volumetrically, and not from either side, as would be the case with either conventional or single microwave source heating. The observed reduction in back pressure from a value of approximately 2.7 psi to slightly more than 1 psi after the microwave heating conclusively demonstrates that the carbon particulates were removed from the filter, and that the filter was successfully regenerated with the microwave heating system.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. A regeneration system comprising:
at least two microwave sources for producing microwaves;
a microwave cavity in communication with the microwave sources to receive the microwaves; and
a particulate filter disposed in the cavity which is heated by the microwaves in the cavity.

2. A regeneration system as described in claim 1 wherein the microwave cavity has multiple ports through which microwaves enter the microwave cavity.

3. A regeneration system as described in claim 2 wherein the microwaves are fed through either waveguides or coaxial cables with wave launchers or electric or magnetic probes into the microwave cavity.

4. A regeneration system as described in claim 2 wherein the microwave sources are protected by means for preventing reflected microwaves from reaching them.

5. A regeneration system as described in claim 4 wherein the preventing means includes isolators or circulators or the particulate filter itself.

6. A regeneration system as described in claim 2 including acoustic isolation for protecting the microwave sources from vibration damage.

7. A regeneration system as described in claim 2 including means for protecting the microwave sources from exhaust and an engine for producing the exhaust connected to the cavity.

8. A regeneration system as described in claim 7 wherein the exhaust protecting means includes windows disposed between the cavity and the microwave sources.

9. A regeneration system as described in claim 2 including control means for turning the microwave sources on or off at desired intervals and in any desired sequence.

10. A regeneration system as described in claim 2 including means for optimizing coupling of the microwaves from the microwave sources to the cavity and the filter.

11. A regeneration system as described in claim 10 wherein the optimizing means includes 3-stub or iris tuners.

12. A regeneration system as described in claim 2 including diagnostics are used to monitor the filter.

13. A regeneration system as described in claim 12 wherein the diagnostics include thermocouples, optical pyrometers or imagers.

14. A regeneration system comprising:
at least one microwave source for producing microwaves;
a microwave cavity having a plurality of ports through which microwaves from the microwave source enter the cavity; and
a particulate filter disposed in the cavity which is heated by the microwaves.

15. A method for regenerating a particulate filter comprising the steps of:
passing exhaust through the particulate filter; and
heating the particulate filter from a plurality of directions with microwaves.
